(19) United States
(12) Patent Application Publication
(10) Pub. No.: US 2025/0272239 A1
(43) Pub. Date: Aug. 28, 2025

(54) NETWORK-ON-CHIP HAVING AN INTEGRATED CACHE CONTROLLER CIRCUITRY

(71) Applicant: XILINX, INC., San Jose, CA (US)

(72) Inventor: Noel James BRADY, Dublin (IE)

(21) Appl. No.: 18/589,379

(22) Filed: Feb. 27, 2024

(51) Int. Cl. G06F 12/0802

(52) U.S. Cl. CPC G06F 12/0802

(57) ABSTRACT

An integrated circuit device includes logic circuitry and a Network-on-Chip (NoC). The logic circuitry performs one or more operations of an application. The NoC is coupled to the logic circuitry via a NoC master unit (NMU). The NoC includes cache controller circuitry that receives a first memory command from the logic circuitry via the NMU. Further, in response to data associated with the first memory command being stored within a cached memory, the cache controller circuitry executes the first memory command on the data of the cache memory.

### TECHNICAL FIELD

Examples of the present disclosure generally relate to an integrated circuit device having a network-on-chip, which has an integrated cache controller circuitry that controls a cache memory for a programmable logic circuitry of the integrated circuit device.

### BACKGROUND

An integrated circuit (IC) device includes a programmable logic circuitry. The programmable logic circuitry includes circuitry that is configurable based on configuration data. The configuration data is used to configure elements of the programmable logic circuitry to perform one or more operations of an application. To complete the operations, data is read from and/or written to a memory device external to and coupled with the IC device. However, access times of the external memory device may function as a bottleneck, reducing performance of the IC device. Cache memory may be used to store local copies of data of the external memory device. However, the implementation of cache memories for programmable logic introduces increased design and programming costs, circuit area costs, and power costs, increasing the cost of the corresponding IC device.

### SUMMARY

In one example, an integrated circuit (IC) device includes logic circuitry and a Network-on-Chip (NoC). The logic circuitry performs one or more operations of an application. The NoC is coupled to the logic circuitry via a NoC master unit (NMU). The NoC includes cache controller circuitry that receives a first memory command from the logic circuitry via the NMU. Further, in response to data associated with the first memory command being stored within a cached memory, the cache controller circuitry executes the first memory command on the data of the cache memory.

In one example, a system includes an IC device. The IC device includes a memory controller, logic circuitry, and a NoC. The memory controller is coupled to a memory device. The logic circuitry performs one or more operations of an application. The one or more operations include read commands for the memory device. The NoC includes cache controller circuitry, a NMU that couples the logic circuitry with the cache controller circuitry, and a NSU that couples the cache controller circuitry with the memory controller. The cache controller circuitry receives a first memory command from the logic circuitry via the NMU. Further, in response to data associated with the first memory command being stored within a cache memory, the cache controller circuitry executes the first memory command on the data of the cache memory.

In one example, a method includes receiving, by cache controller circuitry of a NMU of a NoC of an IC device, a first memory command from logic circuitry. The cache controller circuitry is disposed within the NoC, and the logic circuitry outputs the first memory command via the NMU. The method further includes, in response to data associated with the first memory command being stored within a cache memory, executing, by the cache controller circuitry, the first memory command on the data of the cache memory by outputting the data to the logic circuitry via the NMU when the first memory command is a read command or by overwriting the data of the cache memory when the first memory command is a write command.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a block diagram of an integrated circuit (IC) device.

FIG. 1B illustrates a block diagram of a Network-on-Chip of an IC device.

FIG. 1C illustrates a block diagram of a portion of a Network-on-Chip.

FIG. 2 illustrates a block diagram of a system including an IC device, and a memory device.

FIG. 3 illustrates a block diagram of a system including an IC device.

FIG. 4 illustrates a block diagram of a system including an IC device.

FIG. 5 illustrates a block diagram of a system including an IC device.

FIG. 6 illustrates a flowchart of a method for operating a cache memory.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Integrated circuit (IC) devices include programmable logic (PL) circuitry that is configured to perform one or more operations of a corresponding application. Configuration data is generated based on the application and is used to configure the PL circuitry. Performing the operations includes reading and writing data to a memory device that is external to and connected to the corresponding IC device. As the memory device is external to the IC device, accessing the external memory device adds latency to the corresponding read and/or write operations. Additionally, the external memory device is limited in terms of the rate of read and write operations that the external memory device can execute.

A cache memory may be included within or coupled to the PL circuitry, reducing the latency, increasing the memory access rate, and thereby, improving performance of the corresponding IC device. The cache memory stores a local copy of data, which is accessed from the external memory device. Cache controller circuitry is used to control the cache memory. In one example, the cache controller circuitry and cache memory are included within the PL circuitry. Accordingly, the cache controller circuitry and the cache memory use resources of the PL circuitry, which increases the design complexity and design cost of the corresponding IC device. In other examples, dedicated cache controller circuitry and a dedicated cache memory may be included within the IC device. However, there are applications that do not need cache functionality and in those cases, including dedicated cache controller circuitry and cache memory within the IC device increases the cost of the IC device due to the increased circuit area used by the cache controller circuitry and cache memory. In one or more examples, the cache controller circuitry and cache memory may be placed within another IC device. However, placing the cache controller circuitry and cache memory within another IC device, increases the access time of the cache memory, reducing the performance benefits of using a cache memory and increasing the usage of PL circuitry resources. Further, as inter-chip connections are used to couple to the IC device including the cache control circuitry and cache memory, the inter-chip communication interface bandwidth is increased, increasing the power used by the coupled IC devices.

The IC device described in the following integrates the cache controller circuitry within the Network-on-Chip (NoC). As the NoC is coupled to the other elements within the NoC, integrating the cache controller circuitry within the NoC, reduces the complexity in forming the connections between the cache controller circuitry and the memory blocks used as the cache memory. Further, as the NoC receives the transactions between the PL circuitry of the IC device, including the cache controller circuitry within the NoC provides the cache controller circuitry access to the transactions, without increasing the routing and design complexity of the IC device. In one example, the NoC includes one or more regions that are used to communicate transactions to an external memory. The cache controller circuitry is included within such a region and provided access to the transactions for the external memory. Further, the cache memory may be formed from memory blocks within the PL circuitry or within the NoC. Accordingly, including the cache controller circuitry within the NoC reduces the complexity in connecting the cache controller circuitry to the cache memory, as the connections are already present within the NoC. An IC device having cache controller circuitry included within a NoC as described in the following has a reduced cost as the corresponding design, programming, and routing is less complex as compared to IC devices that include cache controller circuitries located outside the NoC, and an increased performance as compared to IC devices that implement cache memories and cache control circuitries externally to the IC devices.

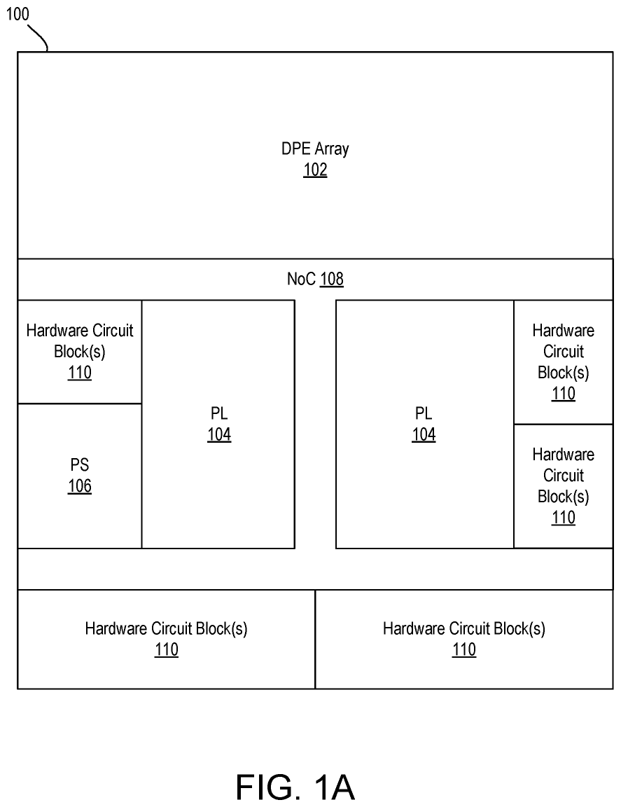

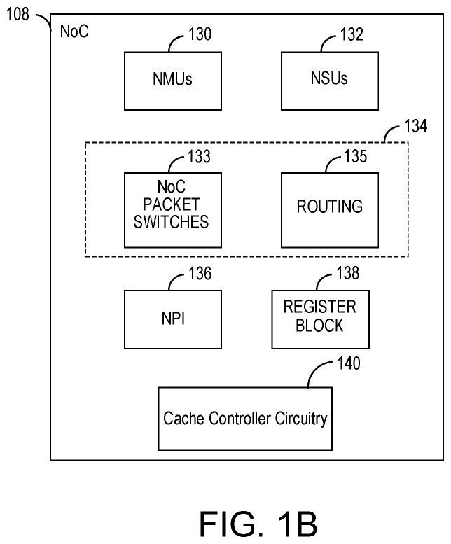

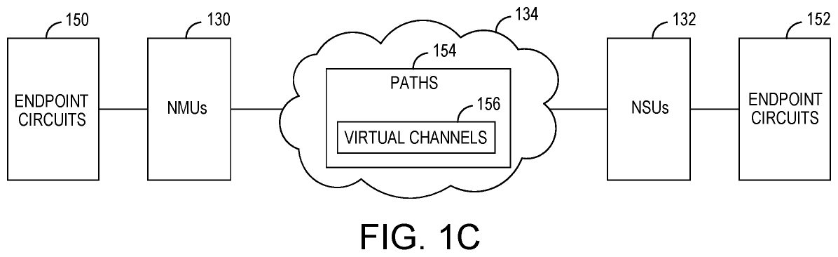

FIG. 1A illustrates an example architecture of an IC device 100, according to one or more examples. In one example, the IC device 100 is a System-on-Chip (SoC). The IC device 100 is an integrated programmable device. The IC device 100 includes one or more IC chips. For example, the circuitry of the IC device 100 may be implemented within one or more IC chips. In an example where the IC device 100 includes two or more IC chips, the two or more IC chips are integrated within a common integrated package.

The IC device 100 includes a data processing (DPE) array 102, programmable logic (PL) circuitry 104, processing system (PS) circuitry 106, NoC 108, and hardware circuit blocks 110. The DPE array 102 is implemented as a plurality of interconnected, hardware, and programmable processors having an interface to other circuit elements within the IC device 100.

The PL circuitry 104 is programmable perform specified functions based on a configuration file. In one example, the PL circuitry 104 is implemented as field programmable gate array (FPGA) type of circuitry. The PL circuitry 104 includes an array of programmable circuitry. In one example, the programmable circuitry within the PL circuitry 104 include, but are not limited to, configurable logic blocks (CLBs), memory blocks, digital signal processing (DSP) circuitry, clock circuitry, and/or delay lock loop (DLL) circuitry, among others.

The programmable circuitry within the PL circuitry 104 includes programmable interconnect circuitry and programmable logic circuitry. The programmable interconnect circuitry includes wires interconnected by programmable interconnect points (PIPs). The interconnected wires provide connectivity on a per-bit basis (in an example where each wire communicates a bit of data). The PL circuitry 104 implements a circuit design using programmable circuit elements that include look-up tables, registers, and/or arithmetic logic, among others. In one example, the programmable circuit elements are programmed by loading configuration data into internal configuration memory cells that define how the programmable elements are configured to operate.

The PS circuitry 106 is implemented as hardware (e.g., hardened) circuitry that is fabricated as part of the IC device 100. The PS circuitry 106 is implemented as, or includes, any variety of different processor types. Each processor type is capable of executing program code. In one example, the PS circuitry 106 is implemented as one or more processors. A processor includes one or more cores. In one example, the PS circuitry 106 includes real-time processing unit (RPU), on-chip memory (OCM), an accelerated processing unit (APU), a graphics processing unit (GPU), and/or peripheral circuitry, among others.

The NoC 108 is interconnect circuitry that provides connectivity to the DPE array 102, the PL circuitry 104, the PS circuitry 106, and the hardware circuit blocks 110. In one example, the NoC 108 is programmable. In such an example, the NoC 108 is a programmable NoC. The NoC 108 may be programmed by loading configuration data into internal configuration registers that define how elements within the NoC 108, such as switches and interfaces are configured and operate to pass data from switch to switch, and among the NoC interfaces.

The NoC 108 is fabricated as part of the IC device 100, and while not physically modifiable, may be programmed to establish connectivity between different master circuits and different slave circuits of a corresponding circuit design. In one example, the NoC 108 includes a plurality of programmable switches that are capable of establishing packet switched network connecting master circuits within slave circuits. The NoC 108 may be adapted to different circuit designs having different combinations of master circuits and slave circuits implemented at different locations within the IC device 100. In one or more examples, the NoC 108 is programmed to route data, e.g., application data and/or configuration data, among the master and slave circuits of a corresponding circuit design. In one example, the NoC 108 couples one or more of the PL circuitry 104 with the DPE array 102, and the hardware circuit blocks 110.

The hardware circuit blocks 110 include input/output (I/O) circuitry and/or transceiver circuitry for sending and receiving signal to circuitry and/or systems external to the IC device 100. In one or more examples, hardware circuit blocks 110 additionally, or alternatively, includes a memory controller. In other examples, I/O circuitry includes single-ended and pseudo differential I/Os and high-speed differentially clock transceivers. In one or more examples, the hardware circuit blocks 110 may be implemented to perform specific functions. Examples of hardware circuit blocks 110 include, but are not limited to, cryptographic engines, and digital-to-analog converters, analog-to-digital converters, among others.

In the example of FIG. 1A, the PL circuitry 104 is shown in two separate regions. In another example, the PL circuitry 104 is implemented as a unified region of programmable circuitry. In one or more examples, the PL circuitry 104 is implemented as more than two different regions of programmable circuitry. In other examples, other configurations of the PL circuitry 104 may be implemented within the IC device 100.

In one or more examples, the IC device 100 includes two or more DPE arras 102 located in different regions of the IC device 100.

FIG. 1B illustrates a block diagram of an example NoC 108. The NoC 108 includes NoC master units (NMUs) 130, NoC slave units (NSUs) 132, switch circuitry (a network) 134, NoC peripheral interconnect (NPI) 136, and register blocks 138. Each NMU 130 is an ingress circuit (e.g., ingress to the NoC 108) that connects a master circuit to the NoC 108. In one example, the NoC 108 is included within an IC device. For example, the NoC 108 is included within an SoC. The NoC 108 functions as interconnect circuitry to connect a processing system and/or other processing circuitry to programmable logic circuitry, hardened logic circuitry, processing logic circuitry, and/or a memory device (or memory devices).

In one example, the NoC 108 includes a series of interconnected horizontal (HNoC) and vertical (VNoC) paths. The HNoC and VNOC paths are supported by a customizable and hardware implemented components that can be configured in different ways based on timing, speed, and logic parameters of the corresponding circuit design. In one or more examples, the HNoC and/or VNoC paths are dedicated, high-bandwidth paths interconnection paths.

Each NSU 132 is an egress circuit (e.g., egress from the NoC 108) that connects the NoC 108 to a slave endpoint circuit. An NMU 130 can, in addition to being an ingress circuit, also have egress capabilities. The NMUs 130 are connected to the NSUs 132 through the switch circuitry 134. In some examples, the switch circuitry 134 includes NoC packet switches (NPSs) 133 and routing 135 between the NPSs 133. Each NPS 133 performs switching of NoC packets. The NPSs 133 are connected to each other and to the NMUs 130 and NSUs 132 through the routing 135 to implement a plurality of paths. The switching capabilities of each NPS 133 permit one or multiple paths to be implemented through each NPS 133. The NPSs 133 also support multiple virtual channels 156 per path.

In one example, NoC 108 provides stream support. Further, the NoC 108 has NMUs and NSUs with a configurable interface width of 32, 64, 128, 256, or 512 bits. In other examples, the configurable interface width may be less than 32 bits or greater than 512 bits. The NoC 108 has 64 bit addressing. In other examples, the addressing may be greater than or less 64 bits.

The NPI 136 includes circuitry to program the NMUs 130, NSUs 132, and NPSs 133. The NPI 136 includes a peripheral interconnect coupled to the register blocks 138 for programming thereof to set functionality of the corresponding NMUs 130, NSUs 132, and NPSs 133. The register blocks 138 in the NoC 108 support interrupts, quality of service (QOS), error handling and reporting, transaction control, power management, and address mapping control. The register blocks 138 for the NMUs 130 and NSUs 132 include registers that can be written to control the operations of the NMUs 130 and NSUs 132. For example, the register blocks 138 can include registers that enable/disable the NMUs 130 and NSUs 132, cause the NMUs 130 and NSUs 132 to not transmit and/or to reject any subsequent transaction request to or from the NPSs 133, and/or instruct the NMUs 130 and NSUs 132 to complete any pending transaction request received from the NPSs 133. The register blocks 138 of the NPSs 133 can include registers that form a routing table for the corresponding NPS 133. The register blocks 138 can be initialized in a usable state before being reprogrammed, such as by writing to the register blocks 138 using write requests. Configuration data for the NoC 108 can be stored and provided to the NPI 136 for programming the NoC 108 and/or other slave endpoint circuits.

The NoC 108 further includes cache controller circuitry 140. The cache controller circuitry 140 connects the NoC 108 to memory elements, and controls the memory elements to function as a cache memory. The memory elements are within the PL circuitry 104 and/or within the NoC 108. The cache controller circuitry 140 is described in greater detail in the following.

FIG. 1C is a block diagram depicting connections between endpoint circuits through the NoC 108 according to an example. In the example, endpoint circuits 150 are connected to endpoint circuits 152 through the NoC 108. The endpoint circuits 150 are master circuits, which are coupled to NMUs 130 of the NoC 108. The endpoint circuits 152 are slave circuits coupled to the NSUs 132 of the NoC 108.

The switch circuitry 134 includes a plurality of paths 154. The paths 154 are implemented by programming the NoC 108. Each path 154 includes one or more NPSs 133 and associated routing 135. An NMU 130 connects with an NSU 132 through at least one path 154. A path 154 can also have one or more virtual channels 156.

In one example, one or more NMUs 130 are connected to one or more NSUs 132. An NMU 130 receives data (e.g., an Advanced extensible Interface (AXI) information or other interconnect protocol information) from an endpoint circuit 150, packetizes the information for transport over the NoC 108 via the NPSs 133 via the paths 154 to an NSU 132. The NSU 132 assembles the packets to re-create the data, and delivers the data to an endpoint circuit 152.

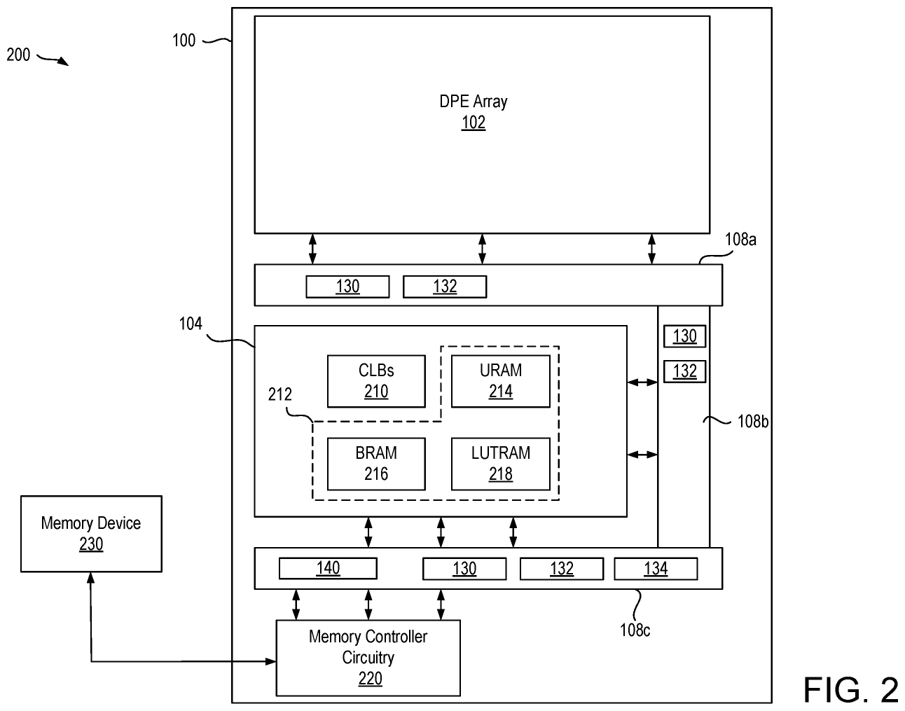

FIG. 2 illustrates a block diagram of a system 200 including the IC device 100, and a memory device 230, according to one or more examples. The memory controller 220 of the IC device 100 is connected with the memory device 230. The memory device 230 is a random access memory (RAM). In one or more examples, the memory device 230 is a dynamic RAM (DRAM).

As is illustrated in FIG. 2, the NoC 108 includes one or more HNoC 108a and 108C and one or more VNoC 108b. A HNoC 108a provide interconnections in a horizontal direction (e.g., a first direction), and the VNoC 108b provides interconnections in a vertical direction (e.g., a second direction orthogonal to the first direction). The HNoC 108a has one or more channels. The VNoC 108b has one or more channels.

The HNoCs 108a, 108c and the VNoC 108b include NoC master units (NMUs) 130, NoC slave units (NSUs) 132 and switch circuitry 134. The HNoCs 108a, 108c and the VNoC 108b further include NoC packet switches (NPS) and/or NoC Inter-Die-Bridge (NIDB) circuitry, among others. An NMU 130 is a data traffic ingress point and an NSU 132 is a traffic egress point. Further NMUs 130 are coupled to NSUs 132 via one or more physical and/or virtual channels. In one example, a first end point circuit is coupled to a second end point circuit via an NMU 130, the switch circuitry 134, and an NSU 132. Physical and/or virtual channels are between the NMU 130 and NSU 132. The physical and/or virtual channels may be formed at least partially within the switch circuitry.

In one example, the DPE array 102 is coupled to one or more NMUs 130 and/or NSUs 132 within the HNoC 108a, such that the DPE array 102 is able to communicate with the PL circuitry 104 and/or the memory controller 220. In one example, the memory controller 220 is part of the hardware circuit blocks 110 of FIG. 1. The memory controller 220 is coupled to NMUs 130 and/or NSUs 132 within the HNoC 108a.

The PL circuitry 104 is coupled to NMUs 130 and/or NSUs 132 within the VNoC 108b and/or the HNoCs 108a and 108c, such that the PL circuitry 104 is able to communicate with the DPEs array 102 and/or the memory controller 220.

The PL circuitry 104 includes an interconnect network coupled to logic elements of the PL circuitry 104. The logic elements include CLBs 210. The PL circuitry 104 includes one or more CLBs 210. The CLBs 210 are disposed in columns. In other examples, the CLBs 210 are disposed in other configurations. The CLB 210 performs one or more operations associated with logic functions of a corresponding application. The PL circuitry 104 further includes memory elements 212. The memory elements 212 are coupled to the CLBs 210 via the interconnect network of the PL circuitry 104. The memory elements 212 include one or more of UltraRAM (URAM) 214, block RAM (BRAM) 216, and/or look-up-table RAM (LUTRAM). In other examples, the memory elements 212 may include other types of memories. The memory elements 212 store data used by the CLBs 210 to perform one or more functions. In one or more examples, the memory elements 212 store configuration data that define how the CLBs 210 are configured.

The PL circuitry 104 communicates with the memory controller 220 and the memory device 230 via the NMUs 130, the switch circuitry 134, and the NSUs 132 of the HNoC 108a. In one example, the PL circuitry 104 reads data from the memory device 230 via the HNoC 108a, and the memory controller 220. Further, the PL circuitry 104 writes data to the memory device 230 via the HNoC 108a and the memory controller 220. The read and/or write operations correspond to functions (e.g., operations) performed by the CLBs 210 of the PL circuitry 104.

As the memory device 230 is external to the IC device, accessing the memory device 230 adds latency to the read and/or write operations. Additionally, or alternatively, the rate of processing read and/or write operations is limited by the external memory device. The latency may be reduced and the rate increased by storing a local copy of the data stored within the memory device 230. In one example, one or more of the memory elements 212 may be used to as a local cache, providing a local copy of data stored within the memory device 230. In one example, at least a portion of the URAM 214 and/or at least a portion of the BRAM 216 are configured as cache memory. As the URAM 214 and/or the BRAM 216 have better performance parameters (e.g., a faster access time) than the memory device, the latency of read and/or write operations is reduced and rate increased when accessing local copies of data stored within the URAM 214 and/or BRAM 216. To use the memory elements as a cache memory, cache controller circuitry is used. The cache controller circuitry may be included within the PL logic 104. Accordingly, the cache controller circuitry and the cache memory use resources of the PL logic 104, which increases the design complexity and design cost of the IC device. In other examples, dedicated cache controller circuitry and a dedicated cache memory may be included within the IC device 100. However, including dedicated cache controller circuitry and cache memory within the IC device, increases the cost of the IC device 100 due to the increased circuit area used by the cache controller circuitry. As a cache memory may not be implemented by each application that performed by the PL logic 104, including dedicated cache controller circuitry and cache memory may unnecessarily increase the cost of the IC device 100 as applications that do not use the dedicated cache controller circuitry and cache memory are using the higher cost IC device. To allow the increased costs to be avoided, the cache controller circuitry and cache memory may be placed within another IC device. However, placing the cache controller circuitry and cache memory within another IC device, increases the access time of the cache memory, reducing the performance benefits of using a cache memory and increasing the usage of PL circuitry resources. Further, as inter-chip connections are used to couple to the IC device including the cache control circuitry and cache memory, the inter-chip communication interface bandwidth is increased, increasing the power used by the coupled IC devices.

In the example of FIG. 2, the NoC 108 includes cache controller circuitry 140. The cache controller circuitry 140 is disposed (integrated) within a first region of the NoC 108. For example, the cache controller circuitry 140 may be disposed within the HNoC 108c. In other example, the cache controller circuitry 140 is disposed within the HNoC 108a or the VNoC 108b. In one example, the cache controller circuitry 140 is disposed within the NoC 108 region that is coupled to the memory device 230. While the following examples are described with regard to the cache controller circuitry 140 being disposed within the HNoC 108c, in other examples the descriptions can be applied to a cache controller circuitry 140 being disposed within other regions of the NoC 108. In one or more examples, the NoC 108, and the regions of the NoC 108 (e.g., HNoCs 108a, 108c, and the VNoC 108b) is a dedicated hardware block, e.g., hardened circuitry that performs a fixed function that is not able to be changed via programmable code (e.g., configuration data).

The cache controller circuitry 140 is a dedicated cache controller circuitry 140. The cache controller circuitry 140 is coupled with the CLBs 210 and a cache memory that is accessible by the PL circuitry 104. As will be described in further detail in the following, the cache memory may be formed by the memory elements 212, another memory within the PL circuitry 104, or a cache memory disposed within the NoC 108.

The cache controller circuitry 140 is coupled with the CLBs 210 via one or more NMUs 130. Further, the cache controller circuitry 140 is coupled with the memory controller 220 via one or more NSUs 132 and the switch circuitry 134. In one or more examples, cache controller circuitry 140 is coupled with the cache memory via the switch circuitry 134 and one or more NSUs 132. In one example, a CLB 210 is coupled to the HNoC 108c via a first NMU 130 and to the memory controller 220 via the switch circuitry 134 and a first NSU 132. To receive the memory command transactions from the CLB 210, the cache controller circuitry 140 is coupled to the first NMU 130. Further, to communicate the memory command transactions to the memory controller 220 and the memory device 230, the cache controller circuitry 140 is coupled to the switch circuitry 134 and the first NSU. In one or more examples, the cache controller circuitry 140 is directly coupled to the cache memory. In such examples, no NMUs 130, no NSUs 132, and/or no portions of the switch circuitry 134 is used to couple the cache controller circuitry 140 with the cache memory.

In one or more examples, as the cache controller circuitry 140 is coupled to the NMUs 130, NSUs 132 and the switch circuitry 134, memory commands (e.g., memory transaction commands) communicated between the PL circuitry 104 and the memory device 230 via the HNoC 108c and the memory controller 220 are directed to the cache controller circuitry 140 via the NMUs 130, the NSUs 132, and the switch circuitry 134.

The NMUs 130, NSUs 132 and/or the switch circuitry 134 of the HNoC 108c are used by the PL circuitry 104 to communicate with the memory controller 220 and the memory device 230. Accordingly, including the cache controller circuitry 140 within the HNoC 108c provides the cache controller circuitry 140 access to the memory commands (e.g., read and write commands) communicated between the PL circuitry 104 and the memory device 230 via the corresponding NMUs 130 and NSUs 132, and the switch circuitry 134. Further, as the HNoC 108c is used to communicate memory commands from the PL circuitry 104 to the memory device 230, including the cache controller circuitry 140 within the HNoC 108c allows for the cache controller circuitry 140 to receive the memory commands without requiring a more complex routing solution to couple the cache controller circuitry 140 with the PL circuitry 104 and the memory device 230.

As is described above, the cache controller circuitry 140 is coupled to the CLBs 210 via one or more NMUs 130. In one or more examples, the cache controller circuitry 140 is coupled to the NMUs 130 of the HNoC 108c that are connected to the CLBs 210 such that the cache controller circuitry 140 is able to receive the memory commands from the CLBs 210. Transactions between the CLBs 210 and the HNoC 108c are received by the cache controller circuitry 140. In one example, the transactions are memory commands, and the cache controller circuitry 140 executes the memory commands based on the type of memory command (e.g., a read command or a write command). In one or more examples, the cache controller circuitry 140 determines the type of memory command (e.g., a read command or a write command). In one example, the cache controller circuitry 140 determines that a memory command is a read or a write memory request based on the data of the transaction.

The cache controller circuitry 140 performs one or more related cache functions on the received memory commands. In one example, for a read command received from the PL circuitry 104, the cache controller circuitry 140 determines whether or not the data associated with the read command is stored within the cache memory. Based on a determination that the data is stored within the cache memory, the cache controller circuitry 140 outputs the read command to the cache memory to provide the corresponding data to the requesting circuitry (e.g., the CLBs 210 that output the memory command). Based on a determination that the data is not stored within the cache memory, the cache controller circuitry 140 outputs the read command to the memory controller 220 and the memory device 230. The memory device 230 executes the read command and outputs corresponding data to the cache controller circuitry 140 via the memory controller 220. The cache controller circuitry 140 outputs the data to the requesting circuitry and stores the data within the cache memory. In one example, the cache controller circuitry 140 maintains a page table that indicates the addresses and data of the memory device 230 that are stored within the cache memory, and the location of the data within the cache memory. As data is stored within the cache memory, the cache controller circuitry 140 updates the page table accordingly. For a write command, the cache controller circuitry 140 receives the write command and, if the corresponding address and data is determined to be stored in the cache memory, the cache controller circuitry 140 writes the data of the write command to the address within the cache memory. The cache controller circuitry 140 may additionally output the write command to the memory controller 220 and the memory device 230. If the corresponding address and data is determined not to be stored in the cache memory, the cache controller circuitry 140 may write the corresponding data to the cache memory and update the mapping in the page table, and/or output the write command to the memory controller 220 and the memory device 230. The cache controller circuitry 140 is able to perform other cache operations, including memory eviction operations, pre-fetch (pre-cache) operations, preparation of cache lines of the cache memory for the writing of data, and/or cache memory invalidation operations, among others.

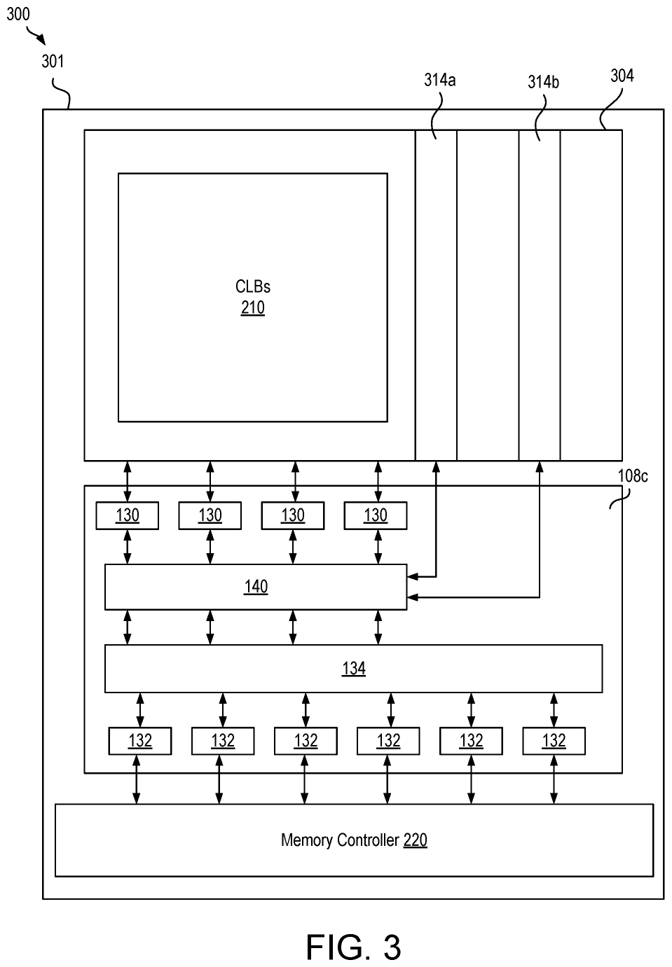

FIG. 3 illustrates system 300 having an IC device 301. The IC device 301 is configured similar to the IC device 100 of FIG. 1A and FIG. 2. As is illustrated the IC device 301 at least includes the PL circuitry 304, the HNoC 108c, and the memory controller 220. The PL circuitry 304 is configured similar to the PL circuitry 104 of FIG. 1A. The IC device 301 may include other elements included within the IC device 100 of FIG. 1A and FIG. 2. The HNoC 108c includes the cache controller circuitry 140. The cache controller circuitry 140 is coupled to the memory columns (or memory devices or memory elements) 314a-314b. A memory column 314 is a memory within the PL logic 104. While not illustrated, in one or more examples, one or more NMUs and/or one or more NSUs 132 couple the cache controller circuitry 140 with the memory columns 314. The CLBs 210 are coupled to and communicate with the memory columns 314a-314b. While two memory columns 314a-314b are illustrated in FIG. 3, in other examples more than or less than to memory columns 314a-314b may be included within the PL circuitry 304.

The memory columns 314 include multiple interconnected memory blocks (e.g., memory circuits). The memory columns 314 may be configured in blocks that are disposed in columns. In other examples, the blocks of the memory columns 314 are disposed in other configurations. In such examples, the memory columns may be referred to as memory elements or memory devices. In one example, the memory columns 314 are comprised of the URAM 214 and/or BRAM 216 in FIG. 2. In other examples, the memory columns 314 include other types of PL memory (e.g., other types of RAM).

One or more of the memory blocks are configured to perform as a cache memory and are coupled to the cache controller circuitry 140. In one example, configuration data is loaded into the memory columns 314 to configure one or more of the memory blocks as a cache memory. In one example, the memory columns 314 include M memory blocks, and N memory blocks are used to form the cache memory. M may be equal to or greater than N. Further, the configuration data couples the cache memory blocks to the cache controller circuitry 140.

In one example, configuration data is provided to the HNoC 108c to enable the cache controller circuitry 140 in examples where a cache memory is implemented. The configuration data further provides an indication of the amount of cache memory that is available and the location of the cache memory within the memory columns 314. In one example, the size of the cache memory is at least 4 MB. In other examples, other sizes of cache memory may be used. The cache memory is used to store cached data as described above, and cache information (e.g., cache tag lines, validity information, and/or least recently used (LRU) cache information). When a cache memory is not implemented, the configuration data provides an indication to the HNoC 108c to disable the cache controller circuitry 140.

The cache controller circuitry 140 communicates with the memory columns 314 that is configured as cache memory as described above to provide a local copy of data stored within the an external memory device, e.g., the memory device 230.

In one example, one or more of the portions of the memory columns 314 that are not configured to be used as cache memory may be used by the CLBs 210 as local memory. The cache controller circuitry 140 is directly coupled with the memory columns 314. In such an example, the cache controller circuitry 140 is coupled to the memory columns 314 similar to as the CLBs 210 (or other circuitry of the PL circuitry 304) are coupled to the memory columns 314. For example, no NMUs, no NSUs, and/or no portions of the switch circuitry 134 is used to couple the cache controller circuitry 140 with the memory columns 314.

As is illustrated in FIG. 3, the cache controller circuitry 140 is coupled to the PL circuitry 304, including the CLBs 210, via one or more NMUs 130. Further, the cache controller circuitry 140 is coupled to the switch circuitry 134, and to the NSUs 132 via the switch circuitry 134. The NSUs 132 couple the switch circuitry 134 to the memory controller 220.

In one example, the cache controller circuitry 140 communicates with the CLBs 210 via the NMUs 130. The cache controller circuitry 140 communicates with the memory controller 220 via the switch circuitry 134 and the NSU 132. Further, the cache controller circuitry 140 communicates with the memory columns 314 via a direct communicate interface.

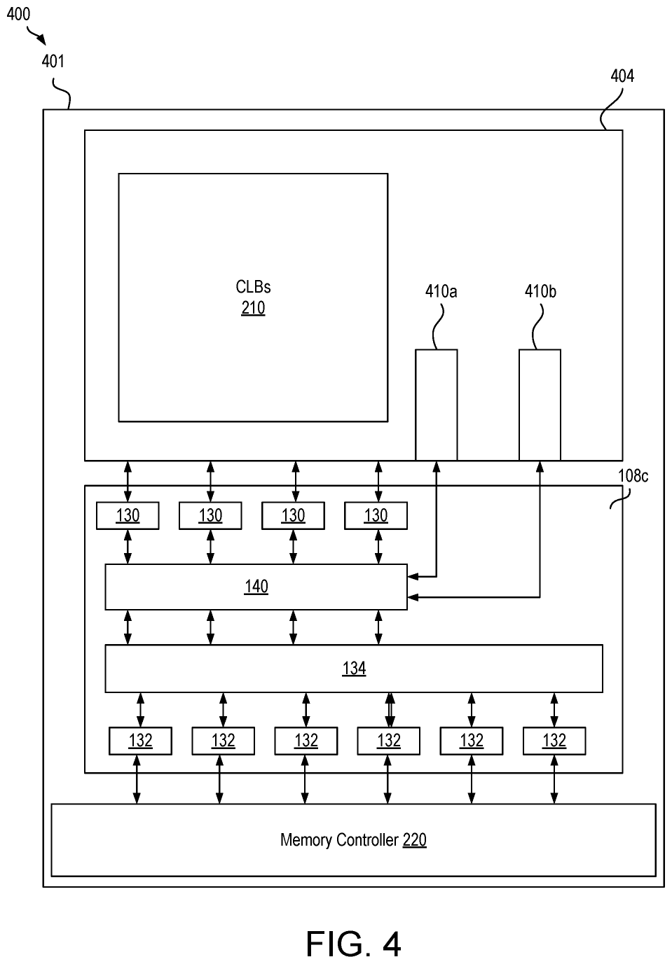

FIG. 4 illustrates a system 400 including an IC device 401 coupled with the memory controller 220. The IC device 401 is configured similar to the IC device 100 of FIG. 1A and FIG. 2. As illustrated the IC device 401 at least includes the PL circuitry 404 and the HNoC 108c. The PL circuitry 404 is configured similar to the PL circuitry 104 of FIG. 1A. The IC device 401 may include other elements included within the IC device 100 of FIG. 1A and FIG. 2.

As is illustrated in FIG. 4, the PL circuitry 404 includes cache RAM 410. The cache RAM 410 includes one or more memory blocks disposed in columns 410a-410b within the PL circuitry 404. In other examples, other configurations of the cache RAM 410 may be used. In the example of FIG. 4, the PL circuitry 404 includes the cache RAM 410 in addition to the URAM 214, the BRAM 216, and the LUTRAM 218 of FIG. 2. The cache RAM 410 differs in one or more of a depth and a width from that of the URAM 214, the BRAM 216, and/or the LUTRAM 218 of FIG. 2. For example, the cache RAM 410 may have a width of 64 bits and a depth of 16 Kbits, while the width of the URAM 214 is 64 bits, and a depth of the URAM 214 is 4 Kbits. In other examples, the cache RAM 410 may have a width that is larger or smaller than 64 bits and a depth that is larger or smaller than 16 Kbits. Additionally, or alternatively, the cache RAM 410 may have other properties that differ from the URAM 214, the BRAM 216, and/or the LUTRAM 218 of FIG. 2. For example, the cache RAM 410 may have a faster access time than the URAM 214, the BRAM 216, and/or the LUTRAM 218 of FIG. 2. In other examples, the cache RAM 410 differs from the URAM 214, the BRAM 216, and/or the LUTRAM 218 of FIG. 2 in an area per bit, number of ports (e.g., single or dual port), and the support of error correction schemes.

The cache controller circuitry 140 of the HNoC 108c may be directly coupled to the cache RAM 410 via an interface. For example, the cache controller circuitry 140 receives from and outputs data directly to the cache RAM 410 via a direct interface, and without the data passing through an NMU 130, an NSU 132, and the switch circuitry. The cache controller circuitry 140 is coupled to the PL circuitry 404, as is described above, to receive transactions via one or more NMUs 130.

In one example, the cache RAM 410 and the HNoC 108c are configured via configuration data as is described above with regard to the IC device 301 of FIG. 3. For example, an amount of the cache RAM 410 used to form a cache memory is determined based on configuration data of an associated application. In one or more examples, the cache controller circuitry 140 is enabled or disabled based on the configuration data indicated that a cache memory is implemented or is not implemented. Cache RAM 410 that is not configured to be used as cache memory may be used by the CLBs 210 as local memory.

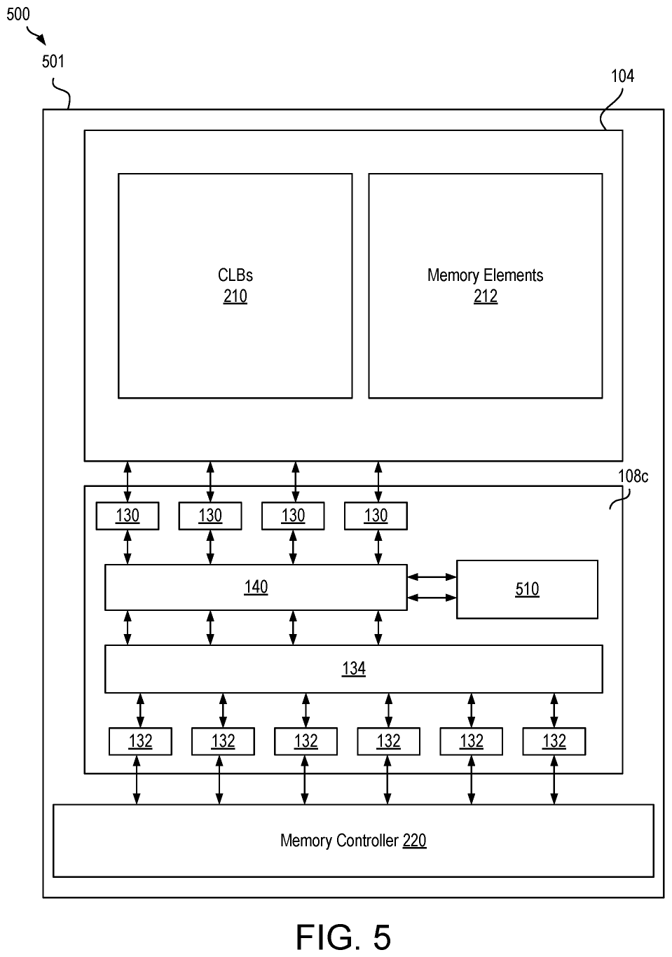

FIG. 5 illustrates a system 500 including an IC device 501 coupled with the memory controller 220. The IC device 501 is configured similar to the IC device 100 of FIG. 1A and FIG. 2. As illustrated the IC device 501 at least includes the PL circuitry 104 and the HNoC 108c. The IC device 501 may include other elements included within the IC device 100 of FIG. 1A and FIG. 2.

As is illustrated in FIG. 5, HNoC 108c includes the cache controller circuitry 140 and memory circuitry 510. The memory circuitry 510 includes one or more memory blocks. The memory circuitry 510 is coupled to the cache controller circuitry 140. The cache controller circuitry 140 is configured to use the memory circuitry 510 as a cache memory as is described above.

The memory circuitry 510 may have a faster access time than the URAM 214, the BRAM 216, and/or the LUTRAM 218 of FIG. 2. In other examples, the memory circuitry 510 differs from the URAM 214, the BRAM 216, and/or the LUTRAM 218 of FIG. 2 in an area per bit, number of ports (e.g., single or dual port), and the support of error correction schemes.

The cache controller circuitry 140 of the HNoC 108c may be directly coupled to the memory circuitry 510. For example, the cache controller circuitry 140 receives data directly from and/or output data directly to the memory circuitry 510. In such an example, additional connections are provided between the cache controller circuitry 140 and memory circuitry 510 within the HNoC 108c. Further, the cache controller circuitry 140 is coupled to the PL circuitry 104 as is described above to receive transactions. In one or more examples, the memory circuitry 510 is coupled to the cache controller circuitry 140 via connections within the HNoC 108c, where other intervening elements of the HNoC 108c are coupled between the cache controller circuitry 140 and the memory circuitry 510.

In one example, the memory circuitry 510 and the HNoC 108c are configured via configuration data as is described above with regard to the IC device 301 of FIG. 3. For example, an amount of the memory circuitry 510 used to form a cache memory is determined based on configuration data of an associated application. In one or more examples, the cache controller circuitry 140 and/or the memory circuitry 510 is enabled or disabled based on the configuration data indicated that a cache memory is implemented or is not implemented. Further, the memory circuitry 510 may be coupled to the PL circuitry 104. In such an example, at least a portion of the memory circuitry 510 not used as cache memory may be used as local memory for the PL circuitry 104 (e.g., for the CLBs 210).

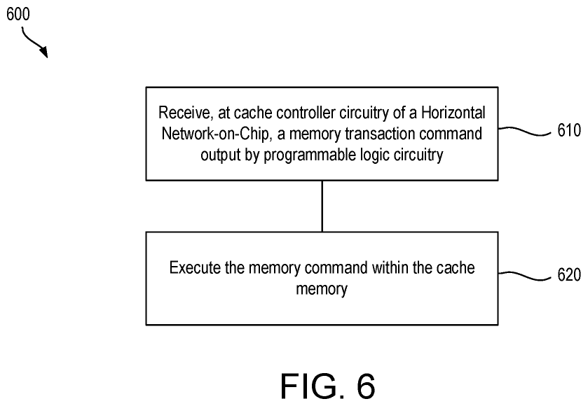

FIG. 6 illustrates a flow chart of a method 600 for operating a cache memory, according to one or more examples. The method 600 is performed by an IC device (e.g., the IC device 100 of FIG. 2, the IC device 301 of FIG. 3, the IC device 401 of FIG. 4 and/or the IC device 501 of FIG. 5).

At 610 of the method 600, a transaction output by PL circuitry is received by cache controller circuitry of a HNoC. For example, with reference to FIG. 2, the CLBs 210 output a transaction to the HNoC 108c. The cache controller circuitry 140 of the HNoC receives the transaction. In one example, the cache controller circuitry 140 is coupled to one or more NMUs of the HNoC 108c that are coupled to the CLBs 210. The cache controller circuitry 140 receives the transaction from the one or more NMUs.

At 620 of the method 600, the memory command is executed. For example, the cache controller circuitry 140 executes the memory command. In an example where the memory command is a read command, the cache controller circuitry 140 determines whether or not the data is available in the cache memory (e.g., the memory columns 314 of FIG. 3, the cache RAM 410 of FIG. 4, or the memory circuitry 510 of FIG. 5). The cache controller circuitry 140 reads the page table to determine whether or not the data is available in the cache memory. In one example, the cache controller circuitry 140 compares an address of the read command with the address of the page table. If the address of the read command is determined to be included within the page table, a cache hit is declared, and the corresponding data is read from the cache memory (e.g., the memory columns 314 of FIG. 3, the cache RAM 410 of FIG. 4, or the memory circuitry 510 of FIG. 5). In one example to read the data, a request is sent from the cache controller circuitry 140 to the cache memory. The data is communicated from the cache memory to the cache controller circuitry 140. If the address of the read command is not determined to be included within the page table, a page miss is declared, and the cache controller circuitry 140 outputs the read command to the memory controller 220 via the switch circuitry 134 and one or more NSUs 132 of the HNoC 108c. The data is obtained from the memory device 230, and output to the cache controller circuitry 140 via the memory controller 220, the switch circuitry 134, and one or more NSUs 132 within the HNoC 108c. The cache controller circuitry 140 writes the data to the cache memory (e.g., the memory columns 314 of FIG. 3, the cache RAM 410 of FIG. 4, or the memory circuitry 510 of FIG. 5), and updates the page table accordingly. Further, the cache controller circuitry 140 outputs the data to the transaction requester (e.g., a CLB 210 of the PL circuitry 104) via an NMU 130.

In an example where the memory command is a write command, the cache controller circuitry 140 determines whether or not the corresponding target address (e.g., address of the data within the memory device 230) is available in the cache memory (e.g., the memory columns 314 of FIG. 3, the cache RAM 410 of FIG. 4, or the memory circuitry 510 of FIG. 5). In one or more examples, the cache controller circuitry 140 populates the cache memory with a new entry and sets the data value to that associated with the write command, or forwards the read command to the memory controller 220 and the memory device 230 to obtain the data associated with the write command from the memory device 230, places the data in the cache memory and executes the write command on the data in the cache memory.

The cache controller circuitry 140 reads a page table to determine whether or not the target address is available in the cache memory. In one example, the cache controller circuitry 140 compares an address of the write command with the address of the page table. If the address of the write command is determined to be included within the page table, the corresponding data is written to the cache memory (e.g., the memory columns 314 of FIG. 3, the cache RAM 410 of FIG. 4, or the memory circuitry 510 of FIG. 5) at the corresponding address. If the address of the write command is not determined to be included within the page table, the cache controller circuitry 140 writes the data to the cache memory and updates the page table accordingly. After writing the data to the cache memory, the cache controller circuitry 140 may also output the write command to the memory controller 220 and the memory device 230 via the switch circuitry 134 and an NSU 132 of the HNoC 108c. In one example, the cache controller circuitry 140 outputs the write command to the memory controller 220 and the memory device 230 without first writing the data to the cache memory. Further, the cache controller circuitry 140 outputs an indication to the transaction requester element (e.g., a CLB 210 of the PL circuitry 104) that the write command is completed via an NMU 130.

The IC device described in the above integrates the cache controller circuitry within a region of the NoC. As the NoC is coupled to the other elements within the NoC, integrating the cache controller circuitry within the NoC, allows for connections between the NoC and the other elements within the IC device to be used by the cache controller circuitry, reducing the complexity in forming the connections between the cache controller circuitry and the cache memory blocks. The cache memory may be formed from memory blocks within the PL circuitry or within the NoC (e.g., the HNoC). Accordingly, including the cache controller circuitry within the HNoC reduces the complexity in connecting the cache controller circuitry to the cache memory. An IC device having cache controller circuitry included within a NoC as described above has a reduced cost as the corresponding design, programming, and routing is less complex as compared to IC devices that include cache controller circuitries located close to the memory controller, and an increased performance as compared to IC devices that implement cache memories and cache control circuitries within the programmable logic circuitry.

While the foregoing is directed to specific examples, other and further examples may be devised without departing from the basic scope thereof, and the scope thereof is determined by the claims that follow.

What is claimed is:

1. An integrated circuit (IC) device comprising:
logic circuitry configured to perform one or more operations of an application; and
a Network-on-Chip (NoC) coupled to the logic circuitry via a NoC master unit (NMU), the NoC comprising cache controller circuitry configured to:
receive a first memory command from the logic circuitry via the NMU; and
in response to data associated with the first memory command being stored within a cached memory, execute the first memory command on the data of the cache memory.

2. The IC device of claim 1, wherein executing the first memory command on the data of the cache memory comprises outputting the data to the logic circuitry via the NMU when the first memory command is a read command or by overwriting the data of the cache memory when the first memory command is a write command.

3. The IC device of claim 1, wherein the logic circuitry comprises memory blocks, and wherein the cache memory comprises one or more of the memory blocks.

4. The IC device of claim 1, wherein the NoC includes the cache memory.

5. The IC device of claim 1, wherein the NoC includes a switch circuitry and a NoC slave unit (NSU), and wherein the cache controller circuitry is configured to communicate with an external memory device via the NSU and the switch circuitry.

6. The IC device of claim 1, wherein the cache controller circuitry is further configured to:
receive a second memory command from the logic circuitry; and
communicate a command to a memory device external to the IC device based on a determination that data associated with the second memory command is not stored within the cache memory.

7. The IC device of claim 1, wherein the NoC is configured to enable or disable the cache controller circuitry based on configuration data associated with the application.

8. The IC device of claim 7, wherein at least a portion of the cache memory is configured to function as local memory for the logic circuitry, and wherein the cache memory comprises one or more memory blocks of the logic circuitry or the cache memory is included within the NoC.

9. A system comprising:
an integrated circuit (IC) device comprising:
a memory controller coupled to a memory device; and
logic circuitry configured to perform one or more operations of an application, the one or more operations include read commands for the memory device; and
a Network-on-Chip (NoC) comprising cache controller circuitry, a NoC master unit (NMU) configured to couple the logic circuitry with the cache controller circuitry, and a NoC slave unit (NSU) configured to couple the cache controller circuitry with the memory controller, wherein the cache controller circuitry is configured to:
receive a first memory command from the logic circuitry via the NMU; and
in response to data associated with the first memory command being stored within a cache memory, execute the first memory command on the data of the cache memory.

10. The system of claim 9, wherein executing the first memory command on the data of the cache memory comprises outputting the data to the logic circuitry via the NMU when the first memory command is a read command or by overwriting the data of the cache memory when the first memory command is a write command.

11. The system of claim 9, wherein the logic circuitry comprises memory blocks, and wherein the cache memory comprises one or more of the memory blocks.

12. The system of claim 9, wherein the NoC includes the cache memory.

13. The system of claim 9, wherein the NoC further includes a switch circuitry, and wherein the cache controller circuitry is further configured to communicate with the memory controller via the switch circuitry.

14. The system of claim 9, wherein the cache controller circuitry is further configured to:
receive a second memory command from the logic circuitry; and
communicate a command to the memory device based on a determination that data associated with the second memory command is not stored within the cache memory, wherein the memory device is external to the IC device.

15. The system of claim 9, wherein the NoC is configured to enable or disable the cache controller circuitry based on configuration data associated with the application.

16. The system of claim 9, wherein at least a portion of the cache memory is configured to function as local memory for the logic circuitry, and wherein the cache memory comprises one or more memory blocks of the logic circuitry or the cache memory is included within the NoC.

17. A method comprising:
receiving, by cache controller circuitry of a Network-on-Chip (NoC) master unit (NMU) of a NoC of an integrated circuit (IC) device, a first memory command from logic circuitry, wherein the cache controller circuitry is disposed within the NoC, and the logic circuitry outputs the first memory command via the NMU; and
in response to data associated with the first memory command being stored within a cache memory, executing, by the cache controller circuitry, the first memory command on the data of the cache memory by outputting the data to the logic circuitry via the NMU when the first memory command is a read command or by overwriting the data of the cache memory when the first memory command is a write command.

18. The method of claim 17, wherein the logic circuitry comprises memory blocks, and wherein the cache memory comprises one or more of the memory blocks.

19. The method of claim 17, wherein the NoC includes the cache memory.

20. The method of claim 17 further comprising:
receiving a second memory command from the logic circuitry; and
communicating, via switching circuitry and a NoC slave unit (NSU) of the NoC, a command to a memory device external to the IC device based on a determination that data associated with the command is not stored within the cache memory.
